(19) United States
(12) Patent Application Publication
(10) Pub. No.: US 2023/0064346 A1
(43) Pub. Date: Mar. 2, 2023

(54) METHOD AND APPARATUS FOR TRIMMING EDGES OF GLASS SUBSTRATES DURING INLINE PROCESSING

(71) Applicant: CORNING INCORPORATED, CORNING, NY (US)

(72) Inventors: Jared David Beckwith, Warriorsmark, PA (US); Nils Paul Fornell, Harrodsburg, KY (US); Misha Andre Gerschel, Skillman, NJ (US); Tae-hun Han, Asan-si (KR); Suk-Ju Kim, Cheonan-si (KR); Yong-shin Kim, Suwon-si (KR); Younghoo Kim, Incheon (KR); Ian Kirk, Horseheads, NY (US); Craig Marshall Phenes, Danville, KY (US); Yu-Ren Wang, Taichung City (TW)

(21) Appl. No.: 17/794,279

(22) PCT Filed: Jan. 19, 2021
(86) PCT No.: PCT/US2021/013899

§ 371 Date: Jul. 21, 2022

Related U.S. Application Data
(60) Provisional application No. 62/966,288, filed on Jan. 27, 2020.

(51) Int. Cl. C03B 33/033; B65G 49/06; C03B 33/03; C03B 33/037; C03B 33/10

(52) U.S. Cl. CPC C03B 33/033; B65G 49/061; C03B 33/03; C03B 33/037; C03B 33/10; B65G 2249/04

(57) ABSTRACT

A method of separating an edge portion from a glass substrate includes applying a scoring tool of a scoring apparatus to a glass substrate to cause the scoring tool to score the glass substrate along a score line as the glass substrate moves relative to the scoring apparatus and applying a breaker bar of a breaker apparatus to the glass substrate as the glass substrate moves relative to the breaker bar to separate an edge portion from the glass substrate along the score line.

### PRIORITY CLAIM AND CROSS-REFERENCE

This application claims the benefit of priority under 35 U.S.C. § 119 of U.S. Provisional Application Ser. No. 62/966,288 filed on Jan. 27, 2020, the content of which is relied upon and incorporated herein by reference in its entirety.

### FIELD

The disclosure relates to methods and apparatuses for the trimming of edges of glass substrates during inline processing. The disclosure also relates to the conveyance of glass substrates in an inline edge trimming process.

### BACKGROUND

Substrates made of glass can be formed from continuous ribbons that are separated into individual panels for subsequent processing. The substrates can be delivered to a customer that can, in turn, manufacture various final products such as flat panel displays or photovoltaic devices that incorporate the substrates. Existing processes, however, can be inefficient or expensive because of the need to transport the substrates through several individual intermediate processing steps between the formation of the glass ribbon at the glass manufacturer and assembly of the glass substrate into a final product.

Edge trimming is an example of such an intermediate process. In edge trimming processes, edge portions of a glass substrate can be separated from the substrate to create a substrate that has the final dimensions that may be required for incorporation of the glass substrate into a final product. There is a need, therefore, for improved edge trimming processes to reduce the amount of time, the amount of handling and/or the cost that is required to trim a glass substrate into a substrate having the dimensions required for incorporation into a final product.

### SUMMARY

The present disclosure provides methods and apparatuses for the trimming of edges of a substrate in an inline arrangement that allows the continuous processing of the substrates. The methods and apparatuses may include conveyance apparatuses and related methods that allow for substrates to change conveyance directions using minimal floor space and allow for faster cycle times over existing or conventional methods.

In one aspect, the present disclosure provides a method for separating an edge portion from a glass substrate. In accordance with some embodiments, such a method includes applying a scoring tool of a scoring apparatus to a glass substrate to cause the scoring tool to score the glass substrate along a score line as the glass substrate moves relative to the scoring apparatus and applying a breaker bar of a breaking apparatus to the glass substrate as the glass substrate moves relative to the breaker bar to separate an edge portion from the glass substrate along the score line.

In another aspect, the present disclosure provides an apparatus for separating an edge portion from a glass substrate. In accordance with some embodiments, such a separating apparatus includes a scoring apparatus comprising a scoring tool configured to score a glass substrate along a score line and a scoring conveyor configured to support the glass substrate and move the glass substrate relative to the scoring apparatus when the scoring tool scores the glass substrate. The separating apparatus can also include a breaking apparatus comprising a breaker bar configured to separate an edge portion from the glass substrate along the score line and a breaker conveyor configured to support the glass substrate and move the glass substrate relative to the breaking apparatus when the breaker bar separates the edge portion from the glass substrate.

In another aspect, the present disclosure provides a method for changing the conveyance direction of substrate in an edge trimming process. In accordance with some embodiments, such a method includes moving a glass substrate in a first conveyance direction into a transfer zone using a first conveyor and transferring the glass substrate from a first transfer position on the first conveyor to a second transfer position on the second conveyor, wherein the first transfer position and the second transfer position are at different vertical heights. The method may also include moving the glass substrate in a second conveyance direction away from the transfer zone, wherein the first conveyance direction and the second conveyance direction are different.

In another aspect, the present disclosure provides a transfer apparatus for changing the direction of substrate in an edge trimming process. In accordance with some embodiments, such a transfer apparatus includes a first conveyor for moving a glass substrate in a first conveyance direction. The first conveyor may include a first downstream end positioned in a transfer zone. The transfer apparatus may also include a second conveyor for moving the glass substrate in a second conveyance direction. The second conveyor may include a second upstream end positioned in the transfer zone that overlaps the first downstream end of the first conveyor. The transfer apparatus may also include a lift unit positioned in the transfer zone comprising a lift actuator and a lifter. The lift actuator can be connected to the lifter to cause the lifter to contact the glass substrate and move the glass substrate from a first transfer position on the first downstream end of the first conveyor to a second transfer position on the second upstream end of the second conveyor.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1 is a plan view block diagram illustrating an exemplary edge trim process in accordance with some embodiments.

FIG. 2 is an isometric view illustrating an exemplary conveyance system that can be used in connection with an edge trim processes of the present disclosure.

FIG. 2A is an isometric view illustrating an exemplary substrate that can be moved using the exemplary conveyance system of FIG. 2 in accordance with some embodiments.

FIG. 3 is an isometric view illustrating an exemplary conveyor that can be used to move substrates into a transfer zone in accordance with some embodiments.

FIG. 4A is an isometric view illustrating an exemplary lift unit that can be used to move substrates in the transfer zone in accordance with some embodiments.

FIG. 4B is an end view of illustrating the lift unit of FIG. 4A positioned in the transfer zone for moving a substrate from a first conveyor to a second conveyor in accordance with some embodiments.

FIG. 5 is an isometric view illustrating an exemplary conveyor that can be used to move substrates away from the transfer zone in accordance with some embodiments.

FIG. 6 is an isometric view illustrating an exemplary conveyor that can be used to move substrates through a centering zone in accordance with some embodiments.

FIG. 7 is an isometric view illustrating an exemplary centering apparatus that can be used in the centering zone in accordance with some embodiments.

FIG. 8 is an isometric view illustrating an exemplary conveyor that can be used in a scoring zone in accordance with some embodiments.

FIG. 9 is an isometric view illustrating an exemplary scoring apparatus that can be used in the scoring zone in accordance with some embodiments.

FIG. 10 is an isometric view illustrating a portion of the scoring apparatus of FIG. 9 in accordance with some embodiments.

FIG. 11 is an isometric view illustrating an exemplary push roll unit that can be part of the scoring apparatus of FIG. 9 in accordance with some embodiments.

FIG. 12 is an isometric view illustrating an exemplary breaking apparatus and an exemplary conveyor that can be used in a breaking zone in accordance with some embodiments.

FIG. 13 is an isometric view illustrating a portion of the exemplary breaker apparatus of FIG. 12 in accordance with some embodiments.

FIG. 14 is an isometric view illustrating an exemplary breaker bar of the breaking apparatus of FIG. 12 in accordance with some embodiments.

FIG. 15 is a side view illustrating the breaker bar of FIG. 14 contacting a substrate in the breaking zone in accordance with some embodiments.

FIG. 16 is an isometric view of another exemplary lift apparatus that can be used in a transfer zone in accordance with some embodiments.

FIG. 17 is an isometric view of an exemplary conveyor that can be used to move a substrate out of a transfer zone in accordance with some embodiments.

FIG. 18 is a flow chart illustrating an exemplary method of separating an edge portion from a substrate in accordance with some embodiments.

FIG. 19 is a flow chart illustrating an exemplary method of changing a conveyance direction of a substrate in accordance with some embodiments.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

The present disclosure provides methods and apparatuses for trimming an edge portion from a substrate, which may be a transparent substrate such as a glass panel configured to be used for manufacturing a device such as a display or photovoltaic device. The substrate can be trimmed from an intermediate size to a final size as may be required for further manufacturing processes, such as for assembly into a display or photovoltaic device. The methods and apparatuses of the present disclosure allow the trimming of the substrate to be performed inline. For purposes of the present disclosure, inline means that the trimming process and accompanying conveyance processes can occur in a sequential process without the need to accumulate the substrates in a buffer or to remove the substrates from one manufacturing line and feed the substrates into a separate trimming process. In this manner, the methods and apparatuses of the present disclosure allow the substrates to be processed more quickly with less handling than existing trimming processes. The methods and apparatuses of the present disclosure have other advantages over existing trimming and conveyance processes as will be further discussed herein.

In some embodiments, the substrate is optically transparent and can be made of glass. Examples of a substrate include, but are not limited to, a glass panel. Unless expressly indicated otherwise, the term “glass substrate” or “glass” used herein is understood to encompass any object made wholly or partly of glass. Glass articles include monolithic substrates, or laminates of glass and glass, glass and non-glass materials, glass and crystalline materials, and glass and glass-ceramics (which include an amorphous phase and a crystalline phase).

Exemplary glasses can include, but are not limited to, aluminosilicate, alkali-aluminosilicate, borosilicate, alkali-borosilicate, aluminoborosilicate, alkali-aluminoborosilicate, and other suitable glasses. Non-limiting examples of glasses include, for instance, IRIS™, and GORILLA® glasses from Corning Incorporated. The glass substrate may be optionally strengthened. In some embodiments, the glass substrate may be strengthened mechanically by utilizing a mismatch of the coefficient of thermal expansion between portions of the article to create a compressive stress region and a central region exhibiting a tensile stress. In some embodiments, the glass substrate may be strengthened thermally by heating the glass to a temperature above the glass transition point and then rapidly quenching. In some other embodiments, the glass substrate may be chemically strengthening by ion exchange.

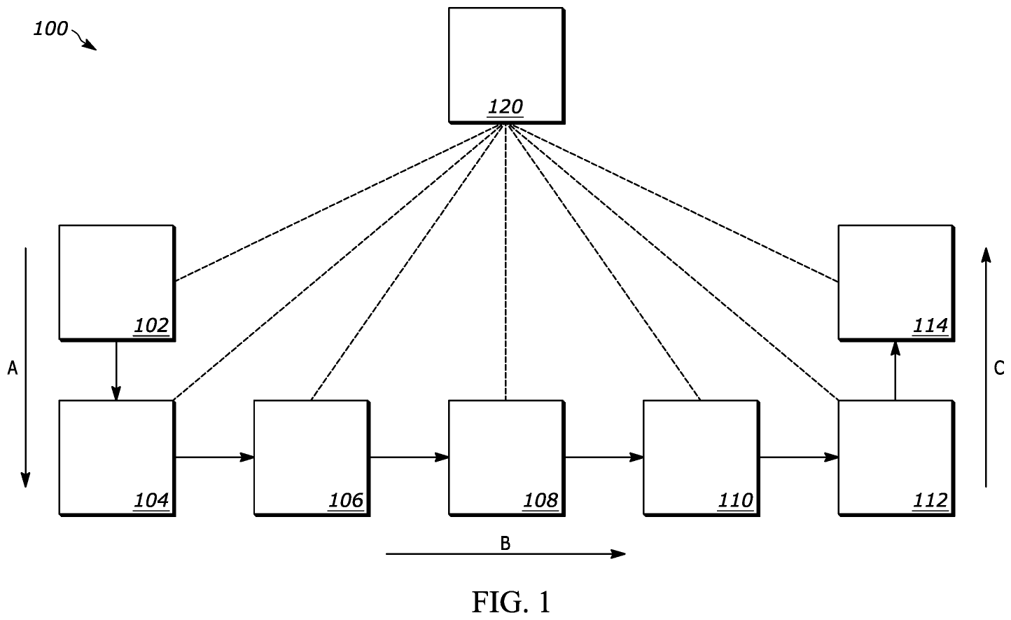

Referring to FIG. 1, a plan view of an edge trimming process 100 is shown. The edge trimming process 100 can include a first processing zone 102, a first transfer zone 104, a centering zone 106, a scoring zone 108, a breaking zone 110, a second transfer zone 112 and a second processing zone 114. The aforementioned zones can be coupled together using one or more conveyors that can move substrates from one zone to an adjacent zone. For example, a first conveyor can move substrates from the first processing zone 102 to the transfer zone 104. During a transfer of substrates from the first processing zone 102 to the transfer zone 104, the substrates can move in a first conveyance direction A as indicated. During a transfer of substrates from the transfer zone to the centering zone 106 or during a transfer of substrates from the centering zone 106 to the scoring zone 108 or during a transfer of substrates from the scoring zone to the breaking zone 110 or during the transfer of substrates from breaking zone 110 to the second transfer zone 112, the substrates can move in a second conveyance direction B. During a transfer of substrates from the second transfer zone 112 to the second processing zone 114, the substrates can move in a third conveyance direction C.

As shown, the edge trimming process 100, in this example, can include two transfer zones in which the substrates change conveyance directions. The conveyance direction A, in this example, is perpendicular to the conveyance direction B. The conveyance direction B, in this example, is perpendicular to the conveyance direction C. In other examples, the conveyance directions can be positioned at other relative angles to one another. In other examples, the conveyance directions can be positioned at acute angles to one another. In still another example, the conveyance directions can be positioned at obtuse angles to one another. In still other examples, the edge trimming process 100 may include one transfer zone that changes the direction of conveyance of the substrates one time.

The edge trimming process 100 and the respective zones shown in FIG. 1 can be positioned in the manner shown due to constraints or limitations in factory floor space or by the need to move the substrates from a predetermined starting location to a predetermined stopping location. As can be appreciated, the layout of the edge trimming process 100 can have other layouts as may be required or desired to fit within the constraints of other processes or other manufacturing environments.

The first processing zone 102, the first transfer zone 104, the centering zone 106, the scoring zone 108, the breaking zone 110, the second transfer zone 112 and the second processing zone 114 can be positioned sequentially to one another as shown. With this relative positioning, substrates can move through the edge trimming process 100 continuously (i.e., without stopping). The substrates can be trimmed inline to a final size without the need to move the substrates to an offline or separate trimming process. Thus, the substrates can be trimmed to a final size more quickly and efficiently than can accomplished using existing or conventional manufacturing processes.

In existing or conventional manufacturing process, a substrate, such as a glass substrate, can be manufactured using a glass production process in which a glass ribbon and/or glass sheet can be produced from suitable batch materials using known glass production methods such as fusion drawing methods, float glass methods and the like. The glass ribbons and/or glass sheets can be separated into glass panels or glass substrates for further processing. In existing and/or conventional glass manufacturing processes, the glass panels or glass substrates can be shipped to a customer with an intermediate size. Glass substrates with an intermediate size are not trimmed to a final size of the glass substrate that will be used by the customer to produce a final product that incorporates the glass substrate (e.g., display, laptop, tablet, etc.). The glass manufacturers, for example, may not be able to efficiently and cost-effectively trim the glass substrates to a final size due to constraints in the glass manufacturing process and/or due to the fact that the glass manufacturers would need to produce many different final sizes of glass substrates from a single type of glass sheet. Given these limitations, in many instances, glass manufacturers may deliver glass substrates to their customers with an intermediate size. The customers, then, can trim the glass substrates from the intermediate size to the desired final sizes.

These existing and conventional glass manufacturing processes have several drawbacks. One drawback is that the customer must trim the glass substrates that have an intermediate size after the glass substrate is delivered to the customer by the glass manufacturer. The trimming of the glass substrate from an intermediate size to a final size can increase the cost of the final product. In addition, the additional handling that may be performed can cause quality issues and/or can result in increased breakage and losses to the customer. Furthermore, when a glass substrate is trimmed at a customer, the glass that is trimmed from a glass substrate cannot be recycled or otherwise reclaimed by the glass manufacturer. The trimmed waste glass is often disposed of using traditional recycling methods rather than being able to be quickly and effectively reclaimed in a glass production process by the glass manufacturer.

The methods and apparatuses of the present disclosure, such as the edge trimming process 100, can address the drawbacks discussed above. For example, since the edge trimming process 100 can be incorporated as part of a glass production process at a glass manufacturer, the glass substrates can be trimmed to a final size before the glass substrates are delivered to the customer. Thus, the customer does not need to perform the handling and trimming at the customer's manufacturing facility that may have been required using existing or conventional methods. In addition, the glass that is trimmed from the glass substrates using the edge trimming process 100, for example, can be collected by the glass manufacturer and reintroduced into the glass forming process. These improvements can improve efficiency, cost and speed for the production of glass substrates over existing and/or conventional processes.

Referring back to FIG. 1, the first processing zone 102 can be a location on the edge trimming process 100 that can be used to perform any processing step that may be required or desired before the substrate moves into the subsequent processing zones. The first processing zone 102 can be a quality control process, weighing process or inspection step, for example. Substrates that exit a glass forming process, for example, can be introduced into the edge trimming process 100 and can move through the first processing zone 102.

The substrates can move from the first processing zone 102 into the first transfer zone 104. The substrates can change from the first conveyance direction A to the second conveyance direction B at the first transfer zone 104. As will be further described, the substrates can change direction in the first transfer zone 104 while maintaining a desired conveyance speed through the transfer zone 104.

The substrates can continue in the second conveyance direction B from the transfer zone 104 to the centering zone 106. The centering zone 106 can include a processing step in which the substrates are moved to a centered position in order to assure that the substrates will have the desired final size after the edge trimming process 100 is complete. The substrates can continue in the second conveyance direction B from the centering zone 106 to the scoring zone 108. The substrates can be scored using a scoring apparatus in the scoring zone 108. The substrates can be scored along one or more score lines that correspond to a desired final size of the substrate.

The substrates can continue in the second conveyance direction B from the scoring zone 108 to the breaking zone 110. The edge portions of the substrates can be separated from the substrates by a breaking apparatus in the breaking zone 110. The edge portions of the substrates can be separated from the substrates along the one or more score lines scored on the substrates in the scoring zone 108. The edge portions that are separated from the substrates can be captured and/or collected for reintroduction and/or recycling into the glass forming process (not shown).

The substrates can continue in the second conveyance direction from the breaking zone 110 into the second transfer zone 112. The substrates can be change direction from the second conveyance direction B to the third conveyance direction C in the transfer zone 112. The substrates can continue in the third conveyance direction C from the transfer zone 112 to the second processing zone 114. The second processing zone 114 can be any suitable process step such as a quality control, measuring, packing, inspection or cleaning step.

As further shown in FIG. 1, the edge trimming process 100 can also include an edge trimming controller 120. The edge trimming controller 120 can be coupled to the apparatuses and/or conveyors in each of the first processing zone 102, the first transfer zone 104, the centering zone 106, the scoring zone 108, the breaking zone 110, the second transfer zone 112 and the second processing zone 114. In this manner, the edge trimming controller 120 can operate to locally or remotely monitor, control and/or adjust a process speed of the substrates through the edge trimming process 100. As can be appreciated, each of the first processing zone 102, the first transfer zone 104, the centering zone 106, the scoring zone 108, the breaking zone 110, the second transfer zone 112 and the second processing zone 114 can be synchronized to allow uninterrupted continuous movement of the substrates through the edge trimming process 100.

The edge trimming controller 120 can be any suitable controller such as a computer, server, logic controller, PLC or the like. The edge trimming controller 120 can be coupled to the first processing zone 102, the first transfer zone 104, the centering zone 106, the scoring zone 108, the breaking zone 110, the second transfer zone 112 and the second processing zone 114 using a suitable wired or wireless connection. The edge trimming controller 120 can also be used to control and/or adjust other operating parameters of the edge trimming process 100.

The edge trimming process 100 is an inline edge trimming processes in that the process can be conducted on or in connection with a glass forming and/or glass production process at a glass manufacturing facility. The substrates that move through the edge trimming process 100 can continuously move through the described zones in order to cost-effectively, efficiently and reliably trim a substrate to a final size before the substrates are delivered to a customer.

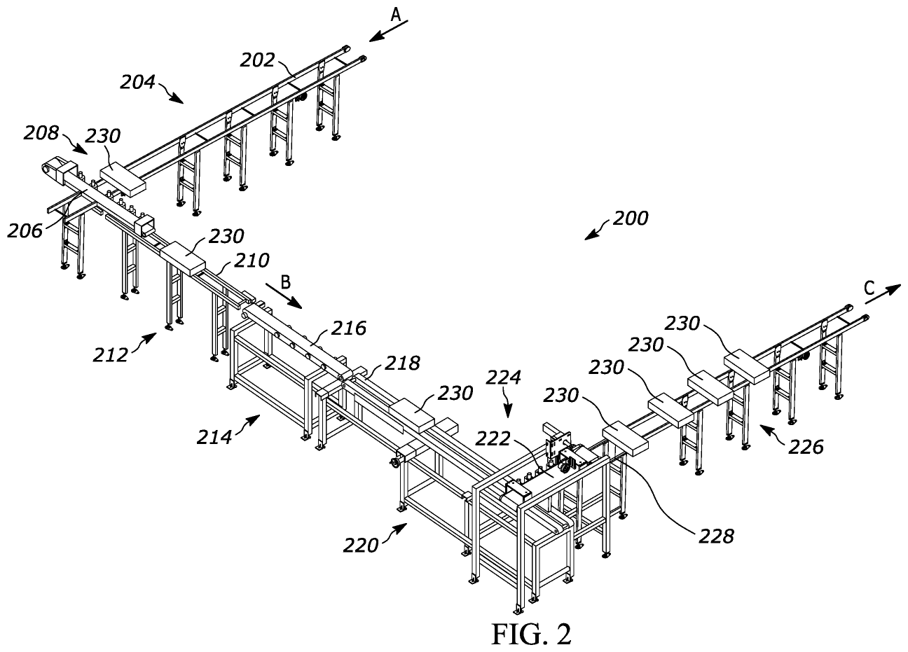

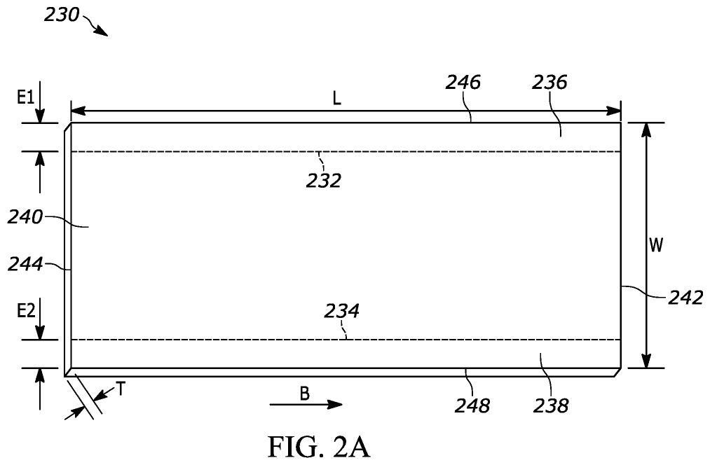

Turning now to FIG. 2, a conveyance system 200 is shown. The conveyance system 200 can be used in connection with the edge trimming process 100 previously described. The conveyance system 200 shows an example of the various conveyors that can be used to move substrates 230 through the edge trimming process 100. In the example shown, the conveyance system 200 can move the substrates 230 in a first conveyance direction A, then along the second conveyance direction B and then along a third conveyance direction C.

An example substrate 230 is shown in FIG. 2A. The substrate 230 can be any suitable shape and can be a glass substrate as previously described. In the example shown, the substrate 230 can be rectangular in shape and can have a thickness T, a width W and a length L. In a preferred example, the substrate is a glass substrate with a thickness T in a range of about 0.9 mm to about 2.3 mm. In other examples, the thickness T can have other sizes such as in the range of about 0.5 mm to about 6.0 mm. In still other example, other thicknesses can be used.

In a preferred example, the substrate 230 can have a width in the range of about 200 mm to about 350 mm. In other examples, the width W can be in the range of about 220 mm to about 280 mm. In still other examples, other widths W can be used.

In a preferred example, the substrate 230 can have a length L in the range of about 500 mm to about 700 mm. In other examples, the length L can be in the range of about 560 mm to about 750 mm. In still other examples, other lengths L can be used.

The substrate 230 can also be characterized in terms of a ratio of its length L to its width W. In some examples, the ratio of the length L to the width W is about 2. In another example, the ratio of the length L to the width W is equal to or greater than about 2. In still another example, the ratio of the length L to the width W is equal to or greater than about 3. In other examples, the substrate's 230 length L and width W can have other relative sizes.

The edge trimming process 100 is operable to trim one or more edge portions 236, 238 from the substrate 230. In the example shown in FIG. 2A, the substrate 230 includes a first score line 232 that is located at a distance E1 from a first edge 246. The other side of the substrate 230 includes a score line 234 that is located at a distance E2 from a second edge 248. The edge trimming process 100 can be operable to separate a first edge portion 236 and a second edge portion 238 from the substrate 230 along the first score line 232 and the second score line 234, respectively. When the first edge portion 236 and the second edge portion 238 are separated from the substrate 230, the body portion 240 of the substrate 230 will remain. The score lines 232, 234 can be positioned in a desired location relative to the first edge 246 and the second edge 248 so that the body portion 240 has a desired final size.

The first score line 232 and the second score line 234 can be positioned at any suitable distance E1, E2 from the first edge 246 and the second edge 248, respectively. In one example, the distance E1 and E2 can be in the range of about 10 mm to about 30 mm. In another example, the distance E1 and E2 can be at least 10 mm. In still another example, the distance E1 and E2 can be less than or equal to about 30 mm. In other examples, the edge portions 236 and 238 can have other suitable sizes.

The substrate 230 can be moved through the edge trimming process 100 in a conveyance direction A, B or C. As shown, when the substrate 230 is moved in the conveyance direction B, the substrate can have a leading edge 242 and a trailing edge 244. The edge trimming process 100, as previously described, can operate to move the substrates 230 at efficient and cost-effective rates. One measure of the rate of movement of the substrates 230 through the edge trimming process is cycle time. The cycle time of the edge trimming process 100 means the time required for each substrate 230 to move through any one zone of the edge trimming process 100. In some examples, the edge trimming process 100 can have a cycle time of about 1.8 seconds to about 8.2 seconds. In other examples, the cycle time of the edge trimming process 100 is less than about 2 seconds. In another example, the cycle time of the edge trimming process is less than about 3 seconds. In still another example, the cycle time of the edge trimming process is less than about 4 seconds. These cycle times are significant improvements over existing and/or conventional methods.

Referring back to FIG. 2, the conveyance system 200 can include a first transfer conveyor 202. The first transfer conveyor 202 can move the substrate 230 from the first processing zone 204 (e.g., weigh station) toward the first transfer zone 208. As can be seen, the substrate 230 can move in the first conveyance direction A when on the first conveyor 202. In the first conveyance direction A, the substrate can be moving such that the substrate is positioned transversely on the first conveyor 202. In the transverse orientation, the substrate 230 moves in a direction where the longer side of the substrate (i.e., the side with the length L) is oriented perpendicularly to first conveyance direction A.

In the transfer zone 208, the substrate 230 can change from the first conveyance direction A to the second conveyance direction B. The substrate 230 can be supported by or retained by the second conveyor 206 when the substrate moves out of or away from the transfer zone 208 in the second conveyance direction B. In the second conveyance direction B, the substrate 230 can be oriented longitudinally on the second conveyor 206. In the longitudinal orientation, the substrate 230 moves in a direction where the longer side of the substrate 230 (i.e., the side with the length L) is oriented parallel to the second conveyance direction B.

The substrate 230 can continue to move in the second conveyance direction B and can transfer from the second conveyor 206 to a centering conveyor 210 in the centering zone 212. The substrate 230 can continue to move in the second conveyance direction B and can transfer from the centering conveyor 210 to a scoring conveyor 216 at the scoring zone 214. The substrate can continue to move from the scoring zone 214 to the breaking zone 220 and transfer from the scoring conveyor 216 to a breaking conveyor 218. The breaking conveyor 218 can move the substrate from the breaking zone 220 into the second transfer zone 224. The substrate can be transferred from the breaking conveyor to a third conveyor 222 in the second transfer zone 224 and can change conveyance direction from the B direction to the third conveyance direction C. In the third conveyance direction C, the substrate 230 can be oriented transversely as previously described with respect to the first conveyance direction A. From the transfer zone 224, the third conveyor 222 can move the substrate to the fourth conveyor 228. The fourth conveyor 228 can move the substrate to the second processing zone 226.

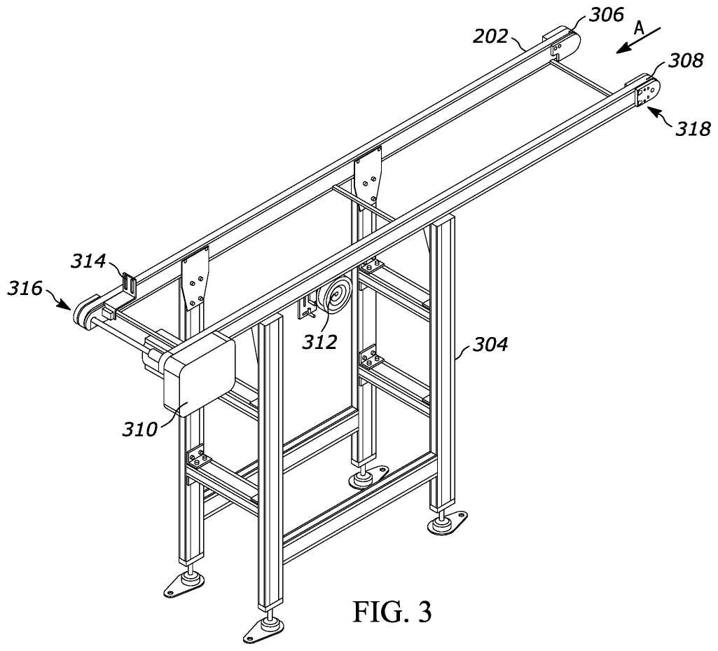

Referring now to FIG. 3, an example of the first conveyor 202 is shown. The first conveyor 202 can be positioned in the conveyance system 200 to move the substrate 230 from the first processing zone 204 to the first transfer zone 208. The first conveyor 202 can move the substrate 230 in the first conveyance direction A.

In the example shown, the first conveyor 202 is a dual belt conveyor. The first conveyor can include a first belt 306 and a second belt 308. The first belt 306 and the second belt 308 can be connected to a support structure 304 to support the first belt 306 and the second belt 308 at a desired height. The support structure 304, in the example shown, includes four legs and a plurality of cross-beams that can securely support the first belt 306 and the second belt 308. In other examples, the support structure 304 can have other configurations.

The first conveyor 202 can include a motor 310. The motor 310 can be coupled to the first belt 306 and the second belt 308 to cause the first belt 306 and the second belt 308 to move at a desired rate to move the substrates 230 as desired. The motor 310 can be any suitable motor and in one example, is an electric motor that can be electrically controlled by the edge trimming controller 120. The first conveyor 202 can also include an encoder 312. The encoder 312 can be any suitable encoder or other sensor that can be used to measure and/or monitor the speed of the first belt 306 and/or the second belt 308. The encoder 312 can also be coupled to the edge trim controller 120, for example, to monitor the operating parameters of the first conveyor 202.

The first conveyor 202 can include a downstream end 316 and an upstream end 318. The downstream end 316 can be positioned at or in the first transfer zone 208. The upstream end 318 can be located at an end opposite to the downstream end 316 and can be located at or near the first processing zone 204. The first conveyor 202 can also include a sensor 314. The sensor 314 can be any suitable sensor such as a proximity sensor that can be used to detect when a substrate 230 has moved into the first transfer zone 208 near the downstream end 316 of the first conveyor 202.

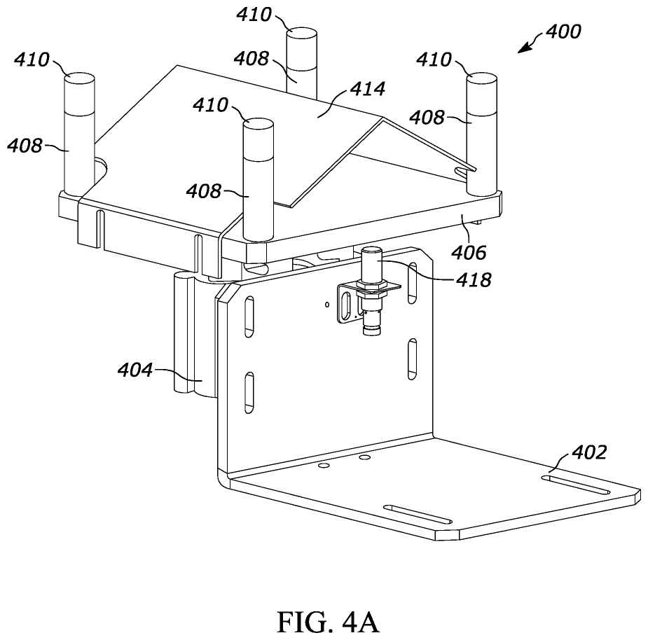

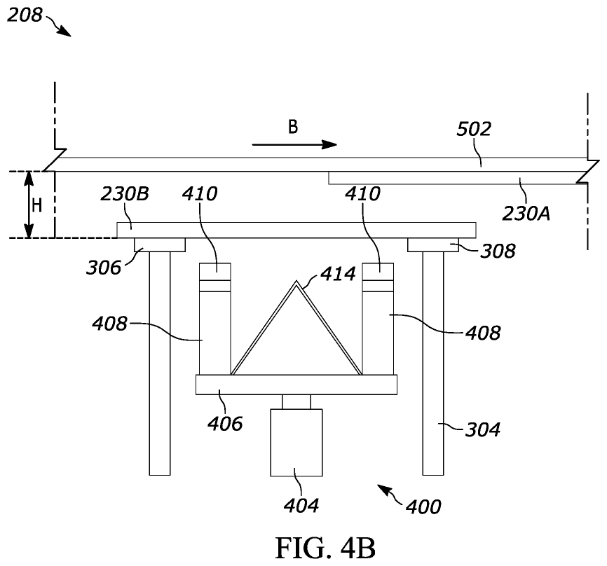

Referring now to FIG. 4A, a first lift unit 400 is shown. The first lift unit 400 can be positioned in the first transfer zone 208 and can be located between the first belt 306 and the second belt 308 of the first conveyor 202. The first lift unit 400 is a device that moves the substrate 230 from a first position in which the substrate is supported by the first conveyor 202 to a second position in which the substrate 230 is supported (or retained) by the second conveyor 206.

The first lift unit 400 can include an attachment structure 402, a lifter 406 and a lift actuator 404. The attachment structure 402 can be an L-bracket or other support element that can be used to attach the first lift unit 400 to the first conveyor 202. The attachment structure 402, for example, can be connected to a cross-beam of the support structure 304 of the first conveyor 202. In other examples, the attachment structure 402 can have other configurations to support the first lift unit 400 in the first transfer zone 208.

The lifter 406 can be connected to the actuator 404. The actuator 404 can be a suitable pneumatic or electric cylinder or other linear actuator that can operate to move the lifter 406 in a vertical direction. The lifter 406 can be a plate that supports one or more spacers 408 and bumpers 410. In the example shown, the lifter 406 includes four spacers 408 positioned at each corner. A bumper 410 can be connected at a distal end of each spacer 408. The spacers 408 can be elongated cylindrical members that can position the bumpers 410 at a vertical height above the uppermost portion of the deflector 414. In this manner, the bumpers 410 can contact the substrate 230 before the deflector 414 can contact the substrate 230. The bumpers 410 can be made of any suitable material to prevent damage to the substrate 230. In some examples, the bumpers 410 can be made of a suitable plastic, polymer, or natural or synthetic rubber. In other examples, other suitable materials can be used.

As further shown, the first lift unit 400 can include the deflector 414. The deflector 414 can operate to deflect pieces of the substrate 230 if the substrate breaks, shatters or otherwise separates into multiple pieces when in the first transfer zone 208. While the bumpers 410 and the movement of the lifter 406 by the actuator 404 can be intended to prevent such failures from occurring, defects or unintended movements may result in the substrate 230 prematurely breaking when positioned in the first transfer zone 208. The deflector 414 can be angled to deflect the substrate 230 from being caught on the first lift unit 400. The deflector 414 can cause pieces of the substrate 230 to be guided toward the floor or other receptacle so that the pieces of the substrate 230 can be recycled or otherwise reclaimed.

The first lift unit 400 can also include a sensor 418. The sensor 418 can be any suitable sensor such as a proximity sensor that can sense a position of the substrate 230 and/or a position of the lifter 406. The sensor 418 can be used to determine, for example, when a substrate 230 is positioned in the first transfer zone 208 and is ready to be moved from a first position in contact with the first conveyor 202 to a second position in contact with the second conveyor 206.

As shown in FIG. 4B, the first lift unit 400 can be positioned below the substrate 230B when the substrate 230B moves into the first transfer zone 208. In the first transfer zone 208, the substrate 230B can be supported on the first belt 306 and the second belt 308 of the first conveyor 202. In this first position, the substrate 230B is also located under a belt 502 of the second conveyor 206. A top surface of the first conveyor 202 can be vertically spaced apart from the bottom surface of the belt 502 of the second conveyor 206 by a height H. When the substrate 230B is in the first position in the first transfer zone 208, the first lift unit 400 can move the substrate 230B upwards to a second position that contacts the belt 502 of the second conveyor 206.

When the substrate 230B contacts the belt 502 of the second conveyor, the substrate 230B can be retained to the belt 502 of the second conveyor. The belt 502 of the second conveyor 206 can, for example, be a vacuum belt that includes a series of holes. A negative pressure can be applied through the holes of the belt 502 to retain the substrate 230B to the underside of the belt 502 of the second conveyor 206. The belt 502 of the second conveyor 206 can be moving in the second conveyance direction B as indicated in FIG. 4B. In this manner, a substrate 230 can change from the first conveyance direction A to the second conveyance direction B in the transfer zone 208. A substrate 230 can move into the first transfer zone 208 in the first conveyance direction A (out of the page as shown in FIG. 4B) on the first conveyor 202 and leave the transfer zone 208 in the second conveyance direction B (to the right on the page as shown in FIG. 4B) on the second conveyor 206.

The method of changing the conveyance direction of the substrate 230 is an improvement over existing and/or conventional transfer processes. The arrangement of the first conveyor 202 and the second conveyor 206 allows substrates to by cycled through the transfer zone 208 more quickly than was possible using traditional methods. In traditional methods, two sequential substrates could only be processed one at a time in the transfer zone 208. In the configuration described and shown, two sequential substrates can overlap one another without interfering with one another because the two sequential substrates can be positioned at different vertical positions in the transfer zone 208. As shown, a first substrate 230A is shown retained to the belt 502 and moving out of the transfer zone 208 by the second conveyor 206. The second substrate 230B is also located in the first transfer zone 208. A portion of the first substrate 230A and a portion of the second substrate 230B overlap one another. The first substrate 230A and the second substrate 230B, however, do not interfere with one another because the first substrate 230A is vertically spaced apart from the second substrate 230B.

This arrangement is further enabled by the arrangement of the first conveyor 202 and the second conveyor 206 in the first transfer zone 208. Referring back to FIG. 2, an upstream end of the second conveyor 206 can overlap the downstream end of the first conveyor 202 in the first transfer zone 208. The upstream end of the second conveyor 206 is, in this example, vertically spaced above the downstream end of the first conveyor 202. Thus, substrates 230 can move into the first transfer zone 208, be lifted from the first conveyor 202 to the second conveyor 206 by the first lift unit 400, and a follower substrate 230 can begin moving into the transfer zone 208 despite the previously lifted substrate still being located in the first transfer zone 208. In this manner, the cycle time of transferring the substrates through the first transfer zone 208 can be increased over existing and/or conventional transfer methods.

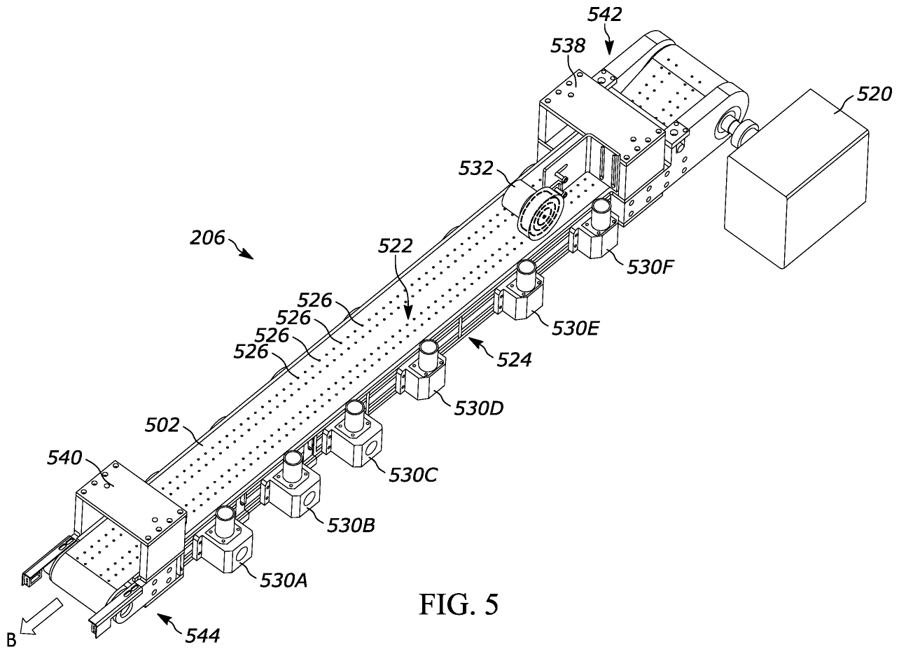

Referring now to FIG. 5, an example second conveyor 206 is illustrated. The second conveyor 206 can include a belt 502 that can be driven at a desired conveyance speed by a motor 520. The second conveyor 206 can be secured in a desired location in the conveyance system 200 using a first bracket 538 and a second bracket 540. The second conveyor 206 can be a vacuum belt conveyor wherein the belt 502 includes a series of openings 526. The second conveyor 206 can also include a series of air attachments 530A to 530 F. The air attachments can allow air conduits to be attached to the second conveyor 206 to allow a negative or positive pressure to be applied to the substrates through the openings 526 on the belt 502. In this manner, the substrates 230 can be suctioned to and retained to the belt 502. The substrates 230 can also be blown off of and released from the belt 502. The belt 502 can move in the second conveyance direction B as shown.

The belt 502 can be moved by the motor 520 at any suitable rate to move the substrates 230 at a desired speed. The second conveyor 206 can also include an encoder 532 that is positioned at or near a top surface 522 of the belt 502. The encoder 532 can measure and/or monitor a speed of the belt 502. The motor 520, the encoder 532 and other elements of the second conveyor 206 can be coupled to the edge trimming controller 120 to synchronize and/or control the operation of the second conveyor 206.

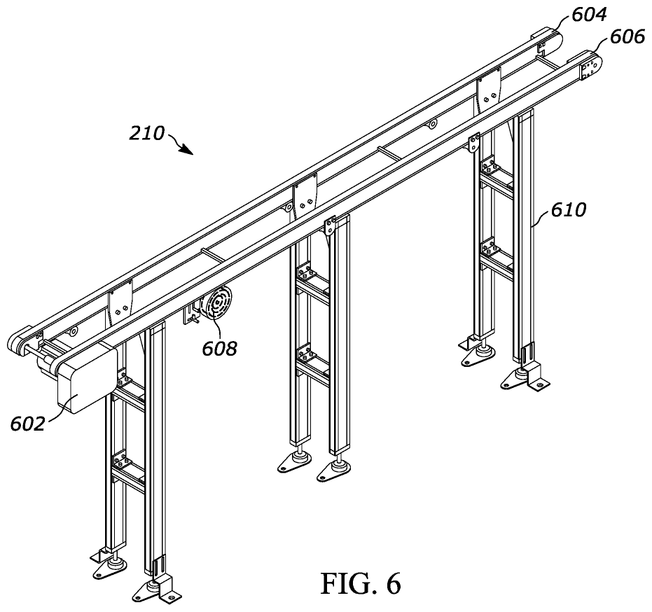

As previously described with respect to movement of the substrates through the first transfer zone 208, the substrates 230 may be retained to the bottom surface 524 of the belt 502. The substrates 230 can be lifted to contact the bottom surface 524 of the belt 502 at or near an upstream end 542 of the second conveyor 206. The substrates 230 can be moved in the second conveyance direction B toward a downstream end 544 of the second conveyor 206. At or near the downstream end 544 of the second conveyor, the substrates can be released from the bottom surface 524 of the belt 502 and dropped on the centering conveyor 210 (FIG. 6).

An example centering conveyor 210 is shown in FIG. 6. As shown, the centering conveyor 210 can be a dual belt conveyor. The centering conveyor 210 can include a first belt 604 and a second belt 606. The centering conveyor 210 can also include a motor 602 and an encoder 608. The centering conveyor 210 can be similar in many respects to the first conveyor 202 previously described. The motor 602 and the encoder 608 can be coupled to the edge trimming controller 120 (FIG. 1) to allow the conveyance speed of the first belt 604 and the second belt 606 to monitored, controlled and/or synchronized with the other conveyors of the conveyance system 200. The centering conveyor 210 can be supported on a support structure 610.

The centering conveyor 210 can move the substrates through a centering apparatus 700 (FIG. 7). The centering apparatus 700 can cause the substrates to be centered on the centering conveyor 210. As can be appreciated, after the substrates are lifted by the first lift unit 400, carried by the second conveyor 206 and released onto the centering conveyor 210, the substrates 230 may not be positioned in a desired position or orientation. The centering apparatus 700 can move the substrates 230 into a desired position and orientation on the centering conveyor 210.

The centering apparatus 700, in the example shown, can include a body portion 702, a first side 704 and a second side 708. The body portion 702 can be positioned under the first belt 604 and the second belt 606 of the centering conveyor 210 so that the substrates 230 pass between the first side 704 and the second side 708. The first side 704 can include a first centering rod 730, a first centering bar 732 and a pair of centering wheels 734. The first side adjuster 706 can be used to move the centering bar 732 in a direction substantially perpendicular to the second conveyance direction B. Similarly, the second side 708 can include a second centering rod 720, a second centering bar 722 and a pair of centering wheels 724. The second side adjuster 710 can be used to move the second centering bar 722 in a direction substantially perpendicular to the second conveyance direction B. Thus, the first centering bar 732 and the second centering bar 722 can be moved inwardly toward the centering conveyor 210 (not shown in FIG. 7) that is positioned therebetween.

The first centering bar 732 and the second centering bar 722 can be positioned relative to the centering conveyor 210 to cause the substrates 230 that pass between the first centering bar 732 and the second centering bar 722 to be centered on the centering conveyor 210. As can be appreciated, if the substrates 230 are skewed or otherwise positioned off center on the centering conveyor 210, the edges of the substrates 230 can contact the first pair of wheels 734 and/or the second pair of wheels 724 that will push the substrates into a centered position. In other examples, the centering apparatus 700 can have other configurations or variations from that shown such as including more wheels 724, 734 or multiple sets of centering bars 722, 732.

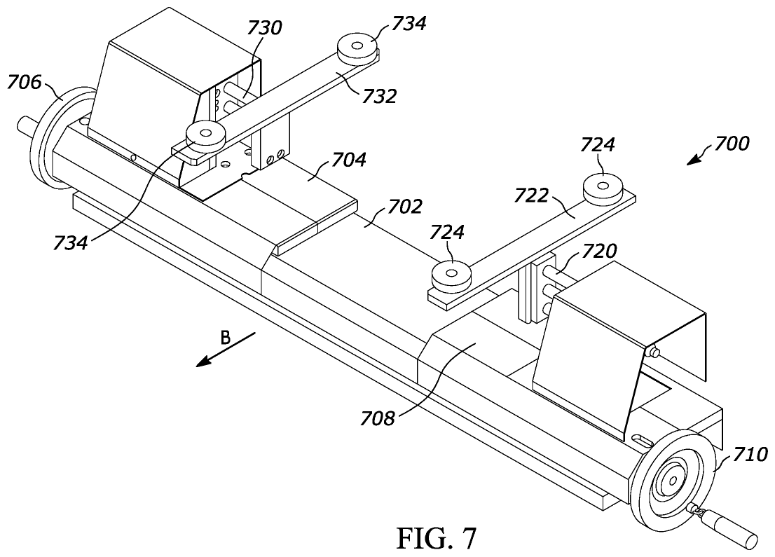

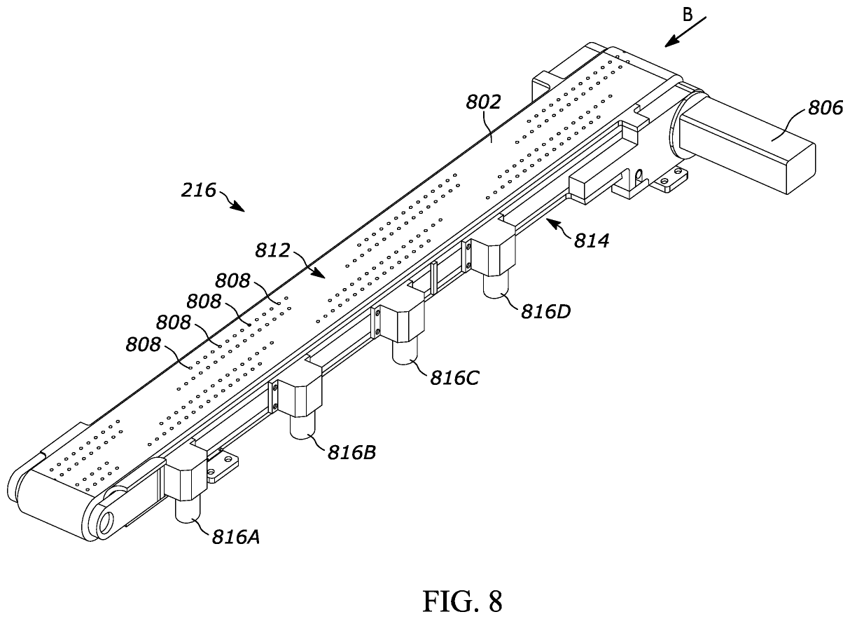

After being centered on the centering conveyor 210, the substrates 230 can move from the centering conveyor 210 to the scoring conveyor 216. An example scoring conveyor 216 is shown in FIG. 8. The scoring conveyor 216, in this example, is a vacuum conveyor that includes a belt 802 with a series of opening 808. One or more air attachments 816A to 816D can be included to apply a negative pressure to the substrates 230 through the openings 808 when the substrates are positioned on a top surface 812 of the belt 802. In this manner, the substrates 230 can be retained to the belt 802 of the scoring conveyor 216 through the scoring zone 214. The scoring conveyor 216 can include a motor 806, such as a servo motor that can be coupled to the edge trimming controller 120 to allow the conveyance speed of the scoring conveyor 216 to be monitored, controlled and synchronized with the other conveyors of the conveyance system 200.

The scoring conveyor 216 can move the substrates 230 through the scoring zone 214 that can include a scoring apparatus 900. The scoring apparatus 900 can be used to score the substrate 230 as the substrate 230 moves relative to the scoring apparatus 900 on the scoring conveyor 216. The scoring apparatus 900 can include a first side 902 and a second side 904 that each can be used to create a first score line 232 and a second score line 234 on the substrate 230 (FIG. 2A). The first side 902 and the second side 904 of the scoring apparatus 900 can be fixed relative to the scoring conveyor 216 on a scoring frame 908. The scoring frame 908 can be a rigid structure that can bolted or otherwise fixed to a support structure that can be used to support the scoring conveyor 216 in position.

The first side 902 and the second side 904 of the scoring apparatus 900 are substantially similar to one another and each side is positioned on a longitudinal side of the substrate 230. The first side 902 of the scoring apparatus 900 can include a first side actuator 910, a first side scoring tool 912, a first prop roller unit 914, a first side vac attachment 920, a first side sensor 922 and a first side adjuster 924. Similarly, the second side 904 of the scoring apparatus 900 can include a second side actuator 946, a second side scoring tool 932, a second prop roller unit 934, a second side vac attachment 940, a second side sensor 942, and a second side adjuster 944.

The first side adjuster 924 and the second side adjuster 944 can move the first side 902 and the second side 904 of the scoring apparatus 900 in directions toward and away from the longitudinal sides of the substrate 230 (i.e., in a direction toward and away from a center of the scoring conveyor 216). In this manner, the position of the scoring lines 232, 234 can be moved relative to the first edge 246 and the second edge 248 (FIG. 2A). Such adjustment can allow the size of the edge portions 236, 238 (that are to be separated from the substrate 230) to be varied according the desired final size of the substrate 230. The first side adjuster 924 and the second side adjuster 944 can be coupled to a worm screw, worm drive, threaded rod, linkage or other suitable structure to cause the first side 902 and/or the second side 904 to move laterally with respect to the scoring conveyor 216 when the first side adjuster 924 and/or the second side adjuster 944 is rotated. In other examples, other suitable adjustment mechanisms can be used.

The first side sensor 922 and the second side sensor 942 can be any suitable sensor such as a proximity sensor. The first side sensor and the second side sensor 942 can operate to detect a leading edge 242 (FIG. 2A) of the substrate 230 as the substrate 230 moves toward the scoring apparatus 900 on the scoring conveyor 216. Once the first side sensor 922 and the second side sensor 942 detects and/or determines that leading edge 242 of the substrate 230 has passed the first side scoring tool 912 and the second side scoring tool 932, the first side actuator 910 and the second side actuator 946 can cause the first side scoring tool 912 and the second side scoring tool 932 to move downward toward the substrate 230. The first side scoring tool 912 and the second side scoring tool 932 can contact the substrate and cause the score lines 232, 234 to be applied to the substrate 230. In the example shown, the substrate 230 moves relative to the first side scoring tool 912 and the second side scoring tool 932. The first side scoring tool 912 and the second side scoring tool 932 are stationary and the substrate 930 moves. This type of movement allows the substrates 230 to continuously and synchronously move inline through the scoring zone 214 in concert with the other zones of the conveyance system 200.

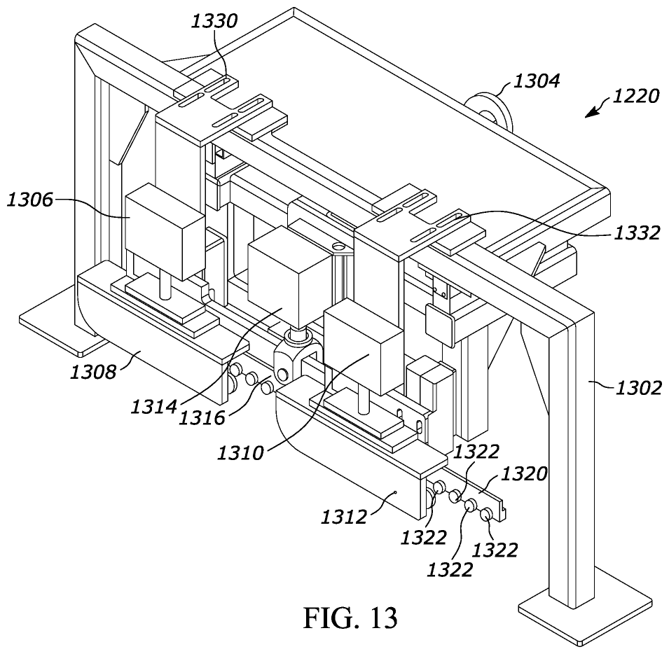

It is desirable to maintain the first side scoring tool 912 and the second side scoring tool 932 in a raised position above the substrate 230 until the leading edge 242 has passed the first side scoring tool 912 and the second side scoring tool 932. This prevents the first side scoring tool 912 and the second side scoring tool 932 from contacting the leading edge 242 of the substrate 230. If the first side scoring tool 912 and/or the second side scoring tool 932 were to contact the leading edge 242 of the substrate 230, chips, defects, cracks, breakage or other undesirable defects can be induced into the substrate 230. It is desirable, however, that the first side scoring tool 912 and the second side scoring tool 932 contact the substrate at a position on the surface of the substrate 230 as close to the leading edge 242 as possible. In some examples, the first side scoring tool 912 and the second side scoring tool 932 contact the substrate 230 at a longitudinal distance of about 1 mm or less from the leading edge 242. In other examples, the first side scoring tool 912 and the second side scoring tool 932 contact the substrate 230 at a longitudinal distance of about 2 mm or less from the leading edge 242. In still other examples, the first side scoring tool 912 and the second side scoring tool 932 contact the substrate 230 at other longitudinal distances from the leading edge 242 that are suitable to prevent chips or other defects to result when the breaking apparatus (e.g., FIG. 13) separates the edge portions from the substrate 230 along the score lines 232, 234.

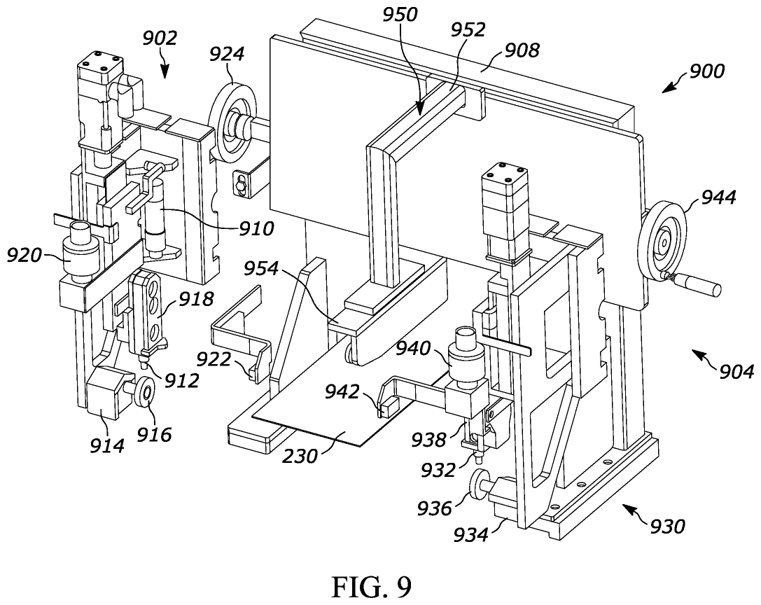

As further shown in FIG. 9, the first side 902 of the scoring apparatus 900 can include the first side prop roller unit 914 and the second side 904 of the scoring apparatus 900 can include the second side prop roller unit 934. The first side prop roller unit 914 can be substantially similar to the second side prop roller unit 934 except that it is positioned symmetrically opposite to the second side proper roller unit 934 on an opposite side of the substrate 230. For the sake of brevity, the first side prop roller unit 914 is described below but it should be understood that the second side prop roller unit 934 with second side prop wheel 936 can have a similar structure and functionality.

The first side prop roller unit 914 can be positioned below the first scoring tool 912. The first side prop roller unit 914 can include a first side prop wheel 916. The first side prop wheel 916 can be positioned under the first side score tool 912. When the substrate 230 moves through the scoring apparatus 900, the first side prop wheel 916 can contact the downward-facing surface of the substrate 230. When the first side scoring tool 912 moves downward and contacts the upward-facing surface of the substrate 230, the first side prop wheel 916 can support the downward-facing side of the substrate 230 under the first side scoring tool 912. Thus, the substrate 230 can pass between the first side scoring tool 912 and the first side prop wheel 916. With this support, the substrate 230 is not subjected to undesirable bending forces or other stresses as the first side scoring tool 912 scores the substrate 230.

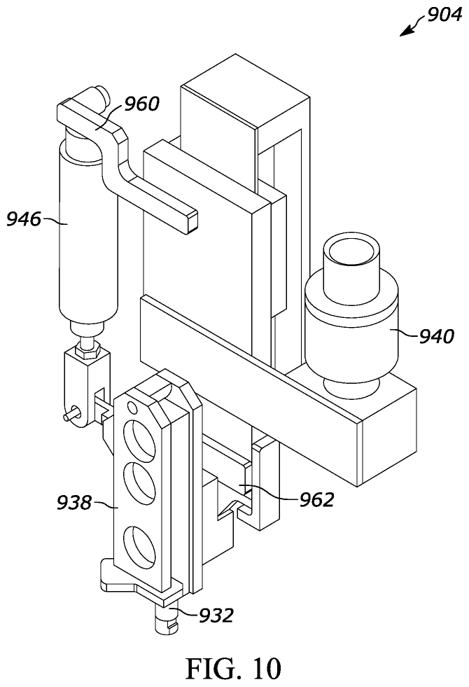

Referring now to FIG. 10, a portion of the second side 904 of the scoring apparatus 900 is shown. As can be seen, the second side 904 can include the actuator 946, the scoring tool 932, the second side vac attachment 940, and a second side oiling unit 938. The actuator 946 can be connected to the body of the second side by a first linkage 960 and a second linkage 962. The first linkage 960 and the second linkage 962 can allow the actuator 946 to cause the scoring tool 932 to move toward the substrate 230 (i.e., downward in FIG. 10 as shown). The actuator 946 can be any suitable actuator such as a linear actuator, cylinder, solenoid or the like. The second side scoring tool 932 can be any suitable scoring tool such as a scoring wheel or the like.

The second side oiling unit 938 can be connected to the second side scoring tool 932. The second side oiling unit 938 can be in communication with or contain a volume of oil or other lubricant that is compatible with the materials of the second side scoring tool 932 and the substrate 230. The second side oiling unit 938 can deliver the oil or other lubricant to the second side scoring tool 932 at or near the location at which the second side scoring tool 932 contacts the substrate 230 during scoring. In this manner, the second side oiling unit 938 can minimize and/or prevent unwanted friction, heat or other negative properties that may result as the second side scoring tool 932 contacts and scores the substrate 230.

The second side vac attachment 940 can be positioned above the second side scoring tool 932. In other examples, the second side vac attachment 940 can be positioned in other locations. The second side vac attachment 940 can allow a vacuum source to be fluidly connected to the second side 904 of the scoring apparatus 900. For example, the vacuum source can be connected at the upper cylindrical portion of the second side vac attachment 940. An extension hose or other suitable extension can be connected to an opposite side of the second side vac attachment 940. The extension hose or other suitable extension can extend toward a location at or near the second side scoring tool 932. When the second side scoring tool 932 contacts the substrate 230, particles, chips or other debris may be created. The extension hose (not shown) that can extend from the second side vac attachment 940 can collect the particles, chips or other debris from the surface of the substrate 230. In other examples, other suitable vacuum sources, blowers or other devices can be used to collect, clean or remove debris from the substrate 230.

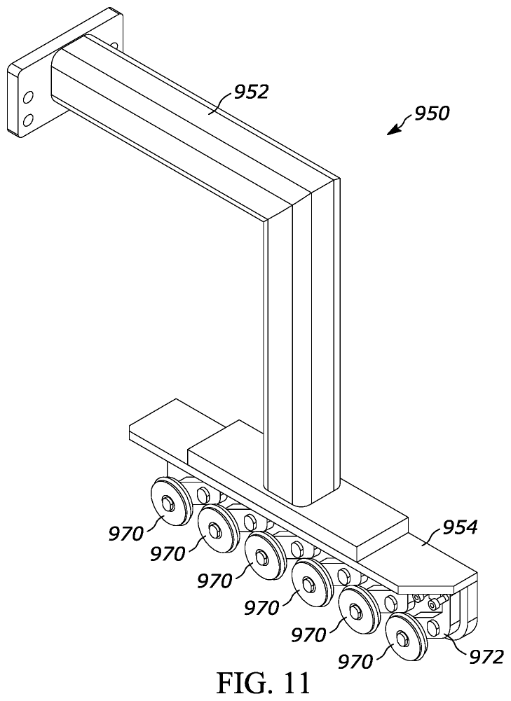

Referring now to FIGS. 9 and 11, the scoring apparatus 900 can also include a push roll unit 950. The push roll unit 950 can be mounted to a center region of the scoring apparatus 900. The push roll unit 950 can be mounted to the scoring frame 908 by a push roll arm 952, for example. In other examples, other suitable support structures can be used to position the push roll arm 952 on the scoring apparatus 900. The push roll unit 950 serves to apply a stabilization force against the substrate 230 to prevent and/or minimize vibration or other undesirable movement of the substrate 230 when the substrate 230 moves through the scoring apparatus 900. As shown, the push roll unit 950 includes one push roll bar 954 that is located at or near the surface of the scoring conveyor 216 such that the push roll bar (or elements thereof) can contact the substrate 230 as the substrate 230 moves through the scoring apparatus 900 to apply the stabilization force. In other examples, the push roll unit 950 may include two or more push roll bars 954 or other suitable structures to apply a stabilization force to the substrate 230.

In the example shown, the push roll bar 954 can include a series of push roll wheels 970 that can each be connected to the push roll bar 954 by a finger extension 972. Each of the finger extension 972 can have a pivot point that allows the finger extension 972 to rotate the push roll wheel 970 that is attached to the finger extension 972 to move toward and away from the substrate 230 (i.e., to move upwards and downwards in FIG. 11). Each finger extension 972 can be biased toward the substrate 230 (i.e., downward in FIG. 11) using a biasing member (not shown) such as a coil spring, leaf spring, compressible bumper, or the like. The properties of the biasing member such as the material, spring constant or the like can be selected in order that a desired stabilization force is exerted against the substrate 230 by the push roll wheels 970 when the substrate 230 moves through the scoring apparatus 900. In the example shown, the push roll unit 950 includes six push roll wheels 970. In other examples, other quantities of push roll wheels 970 or other push members such as push feet, curved leaf springs or the like can be used to apply a stabilization force to the substrate 230.

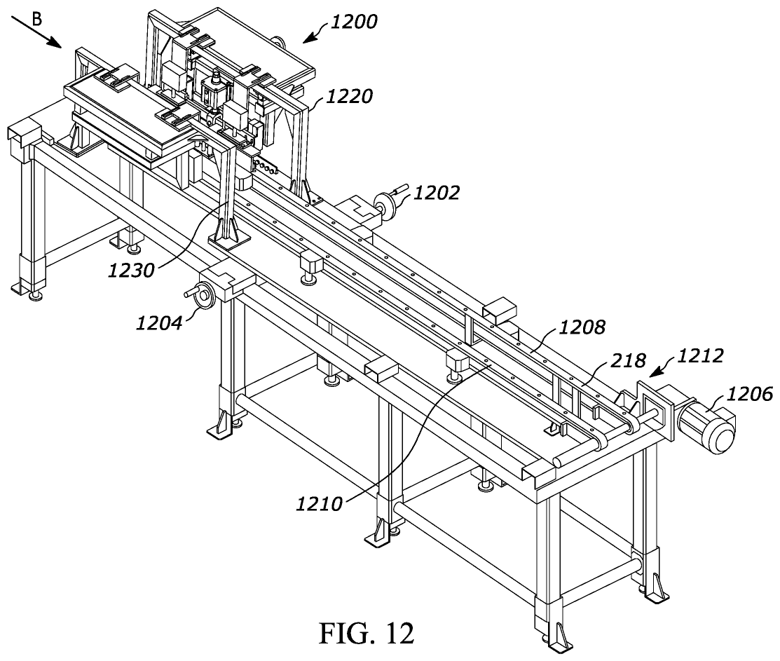

After passing through the scoring apparatus 900, the scoring conveyor 216 can move the substrate 230 in the second conveyance direction B out of the scoring zone 214 and toward the breaking zone 220. The substrate 230 can be moved from the scoring conveyor 216 to the breaking conveyor 218 in the breaking zone 220. As shown in one example in FIG. 12, a breaking apparatus 1200 can be mounted in a desired position relative to the breaking conveyor 218. The breaking apparatus 1200 can include a first breaker assembly 1220 and a second breaker assembly 1230. The first breaker assembly 1220 can be positioned on one side of the substrate 230 and one side of the breaking conveyor 218. The second breaker assembly 1230 can be positioned on an opposite side of the breaking conveyor 218.

The breaking conveyor 218 can be any suitable conveyor and in the example shown is a dual belt conveyor. In this example, the breaking conveyor 218 can include a first belt 1208 and a second belt 1210. The first belt 1208 and the second belt 1210 can be coupled to a motor 1206. The breaking conveyor 218 can also include an encoder (not shown) that can monitor and/or measure the conveyance speed of the first belt 1208 and/or the second belt 1210. The motor 1206 and/or the encoder (and other elements of the breaking apparatus and/or the breaking conveyor 218) can be coupled to the edge trimming controller 120 in order to measure, monitor and/or control the operation of the breaking conveyor 218 and/or the breaking apparatus 1200 to synchronize the operation with other elements of the conveyance system 200.

The breaking conveyor 218 in the example shown can also include a first conveyor adjuster 1202 and a second conveyor adjuster 1204. The first conveyor adjuster 1202 and the second conveyor adjuster 1204 can move the first belt 1208 and the second belt 1210, respectively. The first conveyor adjuster 1202 and the second conveyor adjuster 1204 can be coupled to the first belt 1208 and the second belt 1210, respectively, using any suitable linkage or adjustment mechanism. In some examples, the first conveyor adjuster 1202 and the second conveyor adjuster 1204 can be coupled to a worm gear, threaded rod, rack and pinion mechanism or other suitable device that can cause the first belt 1208 and the second belt 1210 to move toward each other or apart from the other when the first conveyor adjuster 1202 and/or the second conveyor adjuster 1204 is rotated. In other examples, the spacing of the first belt 1208 and the second belt 1210 can be electronically controlled and adjusted using servos, electrical motors, actuators or the like.

It can be desirable to adjust the spacing of the first belt 1208 and the second belt 1210 in order that the first belt 1208 and the second belt 1210 are positioned at or near the score lines 232, 234 of the substrate 230 (FIG. 2A) when the substrate moves through the breaking apparatus 1200. The first belt 1208 and the second belt 1210 can support the substrate 230 at or near the score lines 232, 234 when the edge portions of the substrate 230 are separated.

Referring now to FIG. 13, an example first breaker assembly 1220 is shown. As can be appreciated, the second breaker assembly 1230 can be substantially similar to the first breaker assembly 1220. The second breaker assembly 1230 can be positioned and configured symmetrically opposite to the first breaker assembly 1220. For the sake of brevity, the first breaker assembly 1220 is described below but it should be appreciated that the second breaker assembly 1230 can include similar elements and a similar configuration.

As shown in this example, the first breaker assembly 1220 can include a breaker adjuster 1304, a first holder actuator 1306, a first holder bar 1308, a second holder actuator 1310, a second holder bar 1312, a breaker actuator 1314 and a breaker bar 1316. The breaker adjuster 1304 can be any suitable adjustment mechanism that can be used to adjust the position of the holder bars 1308, 1312 and/or the position of the breaker bar 1316 in a transverse direction (i.e., in a direction perpendicular to the second conveyance direction B). The breaker adjuster 1304 can be used for example to position the holder bars 1308, 1312 on an inboard side of the score line 232 and the breaker bar 1316 on an outboard side of the score line 232. As further shown, the first holder bar 1308 can be further adjusted using a first holder attachment 1330 and the second holder bar 1312 can be further adjusted using a second holder attachment 1332 that can move the holder bars 1308, 1312 relative to the breaker frame 1302.

When the first breaker assembly 1220 is adjusted into position as previously described, the first holder bar 1308 and the second holder bar 1312 can be moved in a direction toward and away from the substrate 230 (i.e., in a direction upwards and downwards as shown in FIG. 13). The first holder bar 1308 and the second holder bar 1312 can be moved using the first holder actuator 1306 and the second holder actuator 1310, respectively. The first holder actuator 1306 and the second holder actuator 1310 can be any suitable actuator such as a linear actuator, cylinder, solenoid or the like.

The first holder bar 1308 and the second holder bar 1312 can each contact the substrate 230 when the substrate 230 moves in the second conveyance direction B through the breaking apparatus 1200. The first holder bar 1308 and/or the second holder bar 1312 can contact the substrate to apply a stabilization force to the substrate 230. The stabilization force is applied to reduce or minimize undesirable vibration or other movement of the substrate 230 in the breaking apparatus 1200.

In the example shown, the first breaker assembly 1220 uses two holder bars (i.e., the first holder bar 1308 and the second holder bar 1312) to contact the substrate 230 in the breaking zone 220. In other examples, the first breaker assembly 1220 can use more or less than two holder bars. It can be desirable, however, to include at least two holder bars so that the individual holder bars can be adjusted more easily and/or with more precision to assure a consistent stabilization force is applied to the substrate 230 over the length of the holder bar(s).

After or simultaneously with the application of the stabilization force, the breaker bar 1316 can be moved by the breaker actuator 1314. The breaker actuator 1314 can be an actuator that is similar to the holder actuators 1306, 1310 previous described. In other examples, the breaker actuator 1314 can be a different cylinder, linear actuator, solenoid or other actuator than the holder actuators 1306, 1310. The breaker actuator 1314 can move the breaker bar 1316 in a direction toward the substrate 230 when the substrate is passing through the breaking apparatus 1200 (i.e., downward as shown in FIG. 13). The breaker actuator 1314 can push the breaker bar 1316 against an upper surface of the substrate at or near the score line 232 to cause the edge portion 236 to separate or break away from the body portion 240 of the substrate (FIG. 2A). Since the substrate 230 was scored along the score line 232 by the scoring apparatus 900, the substrate 230 will break along the score line 232 in a repeatable and efficient manner.

The breaker bar 1316 can have a length that is at least as long as the length L of the substrate 230. With this relative size, the breaker bar 1316 can apply a breaking force along the entire length L of the substrate 230. The breaker bar 1316 can also have one or more breaker wheels 1322 that are positioned along the lower edge of the breaker bar 1316. The breaker wheels 1322 can contact the surface of the substrate 230 as the breaking force is applied to the substrate. While the breaking action of the breaker can be fast motion, the breaker wheels 1322 can limit or minimize friction between the breaker bar 1316 and the substrate 230 that may otherwise exist. This, in turn, improves the quality of the break and the edge conditions of the substrate 230 after the edge portions are separated.

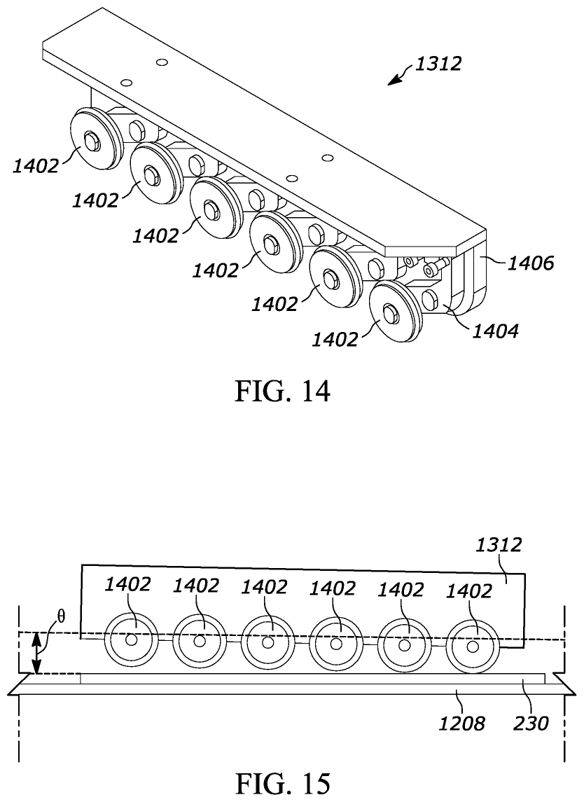

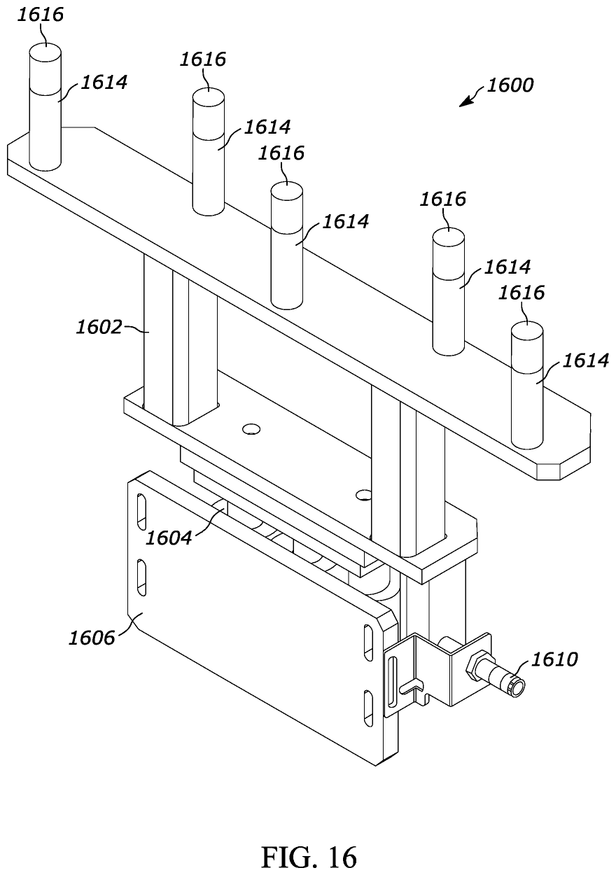

FIG. 14 shows an example holder bar 1312. The holder bar 1312 can be similar to the push roll bar 954 previously described. The holder bar 1312 can include a series of holder wheels 1402 that can each be connected to the holder frame 1406 by a holder finger 1404. The holder fingers 1404 can pivot relative to the holder frame 1406 and be biased in a direction toward the substrate 230. Thus, the holder wheels 1402 can be biased toward the substrate to apply a stabilization force to the substrate when the breaker bar 1316 is applied to the substrate 230.

In some examples, the holder bar 1312 and/or the breaker bar 1316 can be angled relative to the top surface of the substrate 230. As shown in FIG. 15, a downstream end of the holder bar 1312 (or breaker bar 1316) can at a higher vertical position than the upstream end of the holder bar 1312 (or breaker bar 1316). The holder bar 1312 (or the breaker bar 1316) can be positioned at an angle θ relative to the top surface of the substrate 230. This lead-in angle θ may be less than 5 degrees. The lead-in angle θ can reduce the vibration, movement of the substrate 230 in the breaking apparatus 1200 to reduce or limit defects, chips, particle formation, breakage or other undesirable effects.

When the substrate moves through the breaking apparatus 1200 the breaker bars 1316 can be moved to contact the edge portions 236, 238 of the substrate 230 as the substrate moves in the second conveyance direction B. Thus the substrates can be continuously moved throughout the conveyance system 200. As previously described, in existing and conventional edge trimming processes, the edge portions 236, 238 were often separated in a different facility from where the substrate 230 was formed. In the edge trimming process 100, the edge portions 236, 238 can be separated in same facility in which the substrate was formed. Since this is the case, the edge portions 236,238 can be substantially free from contamination and can be easily recycled and/or reclaimed for further use to make further substrates. As such, the edge portions 236, 238 can be collected in the breaking zone 220. While not shown, the breaking zone 220 can include receptacles, or other collectors into which the edge portions 236, 238 can fall after being separated from the substrate 230. These collected edge portions 236, 238 can be recycled and/or reclaimed for melting and forming of new substrates 230.

After the edge portions 236, 238 are separated from the substrate 230, the substrate 230 can move in the second conveyance direction away from the breaking apparatus 1200 and toward a downstream end 1212 on the breaking conveyor 218. The downstream end 1212 of the breaking conveyor 218 can be positioned in the second transfer zone 224. The substrates 230 can be moved to change directions from the second conveyance direction B to the third conveyance direction C in the second transfer zone 224. This process of changing the conveyance direction of the substrate 230 in the second transfer zone 224 can be accomplished using similar structures and a similar process as that discussed with respect to the first transfer zone 208.

For example, a second lift unit 1600 can be positioned between the first belt 1208 and the second belt 1210 of the breaking conveyor 218. The second lift unit 1600 can be similar to the first lift unit 400 in many respects except that the second lift unit 1600 has a narrower profile because the second lift unit 1600 can lift the substrate 230 from between the first belt 1208 and the second belt 1210 when the substrate is positioned in a longitudinal orientation on the breaking conveyor 218 (i.e., the longer side of the substrate 230 is oriented parallel to the conveyance direction B).

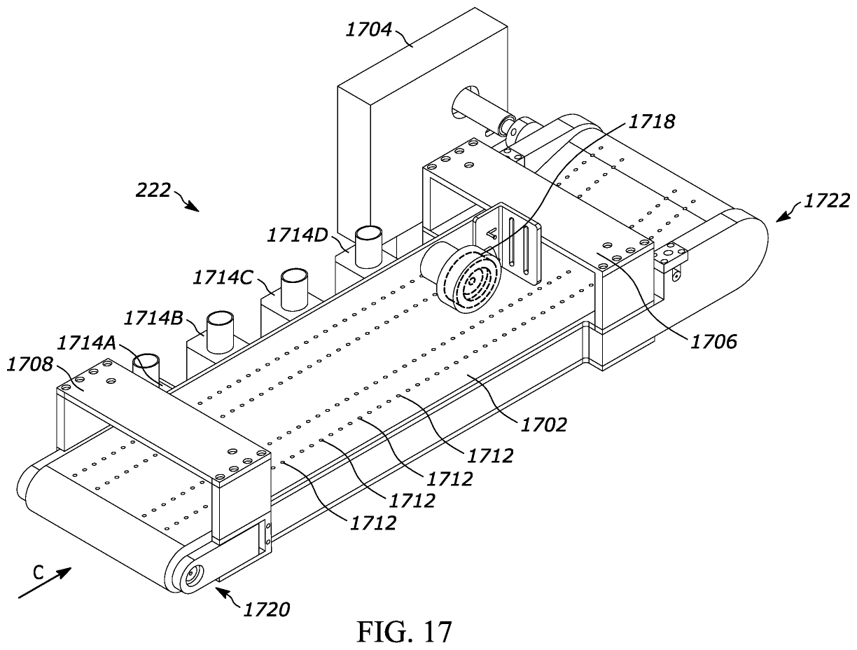

The second lift unit 1600 can include a lift mounting plate 1606 that can be used to connect the second lift unit 1600 to the breaking conveyor 218. The second lift unit 1600 can also include a second lift actuator 1604 that can move the second lift riser 1602 in a direction toward the substrate 230. The bumpers 1616 can be connected at a distal end of spacers 1614. The bumpers 1616 can contact the substrate 230 to move the substrate 230 from a first position in which the substrate 230 is contacting the breaking conveyor 218 to a second position in which the substrate 230 is retained by a third conveyor 222 (FIG. 17).

As shown in FIG. 17, the third conveyor 222 can be a vacuum belt conveyor similar to the second conveyor 206. The third conveyor 222 can include, for example, a belt 1702 with a series of openings 1712. The third conveyor 222 can also include a series of air attachments 1714A to 1714D through which an air source can be applied to apply a negative pressure through openings 1712 to retain the substrate 230 to the belt 1702. In this manner, the substrate 230 can be retained to the bottom surface of the belt 1702. Thus, the substrate 230 can be lifted by the second lift unit 1600 from the breaking conveyor 218 to a bottom surface of the belt 1702. The substrate 230 can be retained to the bottom surface of the belt 1702 and be moved out of the second transfer zone 224 in the third conveyance direction C.

To allow such a transfer, an upstream end 1720 of the third conveyor 222 can be positioned using a first bracket 1706 and a second bracket 1708 in the second transfer zone 224 such that the upstream end 1720 of the third conveyor 222 can overlap the downstream end 1212 of the breaking conveyor 218. The third conveyor 222 can include a motor 1704 and an encoder 1718. The motor 1704 and the encoder 1718 can be coupled to the edge trimming controller 120 in order to measure, monitor and/or control the operation of the third conveyor 222 and/or the second lift unit 1600 to synchronize the operation with other elements of the conveyance system 200.

The substrate 230 can move out of the second transfer zone 224 in the third conveyance direction C and be dropped onto the fourth conveyor 228. The fourth conveyor 228 can be a dual belt conveyor or other suitable conveyor that can further move the substrate 230 into and/or through the second processing zone 226.

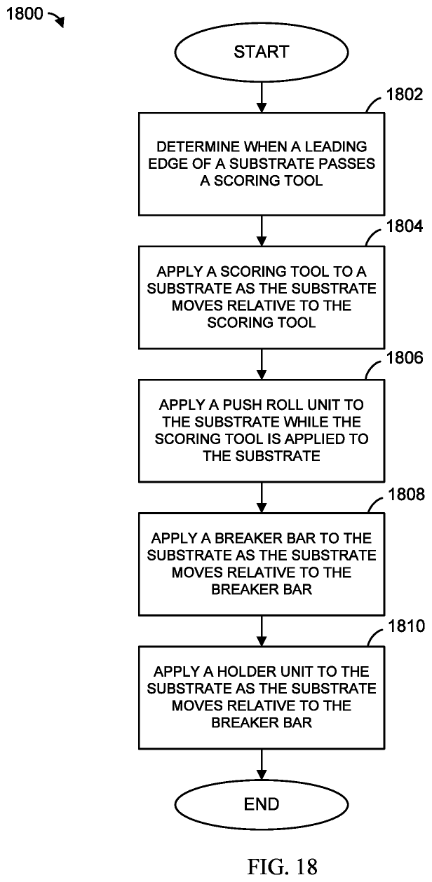

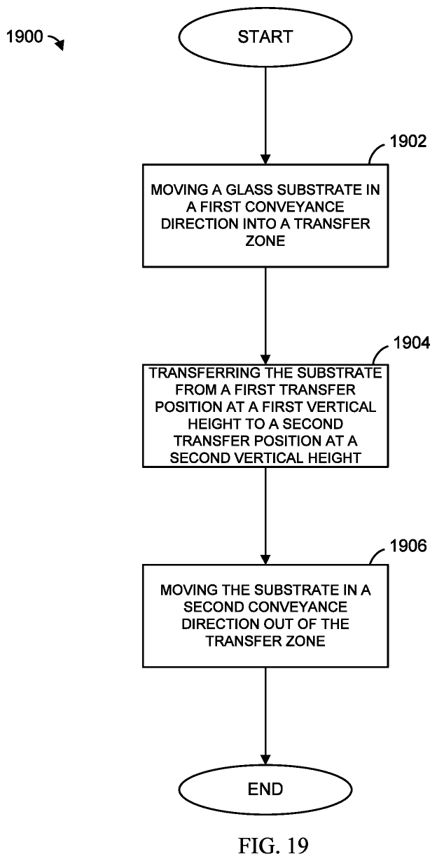

The previously described apparatus and processing details of the edge trimming process 100 and/or the conveyance system 200 can be embodied in one or more methods. In one example method shown in FIG. 18, a method of separating an edge portion from a substrate is illustrated. The exemplary method 1800 begins at step 1802. At step 1802, a scoring apparatus can determine when a leading edge of a substrate passes a scoring tool. In one example, the scoring apparatus 900 can determine when the leading edge 242 of the substrate 230 has passed the scoring tool 912 or 932 using the first side sensor 922 or the second side sensor 942. In other examples, other suitable sensors or other optical devices can be used.

At step 1804, a scoring tool can be applied to the substrate as the substrate moves relative to the scoring tool. In the example discussed above, the scoring apparatus 900 can cause the first side actuator 910 and/or the second side actuator 946 to move the first side scoring tool 912 and the second side scoring tool 932 to move into contact with the substrate 230 to score the substrate along the score lines 232, 234. The scoring conveyor 216 can move the substrate 230 relative to scoring apparatus 900 while the scoring tools 912, 932 score the substrate 930.

At step 1806, a push roll unit can be applied to the substrate while the scoring tool is applied to the substrate. In the examples described above, the scoring apparatus 900 can hold the push roll unit 950 in position while the push roll wheels 970 contact the substrate 230 and apply a stabilization force to the substrate 230 as the substrate 230 moves relative to the scoring apparatus 900 on the scoring conveyor 216.

At step 1808, a breaker bar can be applied to the substrate to separate an edge portion from the substrate along the score line as the substrate moves relative to the breaker bar. In the examples described above, the breaking apparatus 1200 can move the breaker bar 1316 into contact with the substrate 230 at or near the score lines 232, 234 to cause the edge portions 236, 238 to separate from the substrate at the score lines 232, 234. As this occurs, the substrate 230 is moving relative to the breaking apparatus 1200 on the breaking conveyor 218.

At step 1810, a holder unit can be applied to the substrate to apply a stabilization force to the substrate as the substrate moves relative to the breaker bar. In the examples described above, the breaking apparatus 1200 can move the first holder bar 1308 and/or the second holder bar 132 to contact the substrate 230 to apply a stabilization force to the substrate 230 as the substrate 230 moves relative to the breaking apparatus 1200 on the breaking conveyor 218.

As can be appreciated, the steps of the method 1800 can include other steps or can be simultaneously applied to multiple sides of the substrate 230. The steps of method 1800 can be repeatedly applied to subsequent substrates 230 as multiple substrates 230 are continuously moved inline through the conveyance system 200.

In another example method, a method 1900 of changing a conveyance direction of a substrate is shown. The method 1900 begins at step 1902. At step 1902, a substrate can be moved in a first conveyance direction into a transfer zone using a first conveyor. In the examples shown above, the method 1900 can be applied, for example, in the first transfer zone 208. The method 1900 can also be applied in the second transfer zone 224. For the sake of brevity, the method 1900 is described in the context of the first transfer zone 208. At step 1902, for example, the first conveyor 202 can move the substrate 230 into the transfer zone 208 in the first conveyance direction A.

At step 1904, the substrate can be transferred from a first transfer position on the first conveyor to a second transfer position on a second conveyor. The first transfer position and the second transfer positions can be at different vertical heights. In the example first transfer zone 208 described above, the first lift unit 400 can move the substrate 230 from a first position on the first conveyor 202 to a second position on a bottom surface of the second conveyor 206. The position of the substrate 230 on the first conveyor 202 is at a different vertical height than the position of the substrate 230 on the second conveyor 206. In this example, the substrate is lifted from a first position to a second position that is above the first position. In other examples, the configuration can be inverted and the substrate 230 can move from a first position to a second position in which the second position may be lower than the first position. In such alternate examples, the substrate may drop from the first position to the second position. The first conveyor 202 and the second conveyor 206 can be switched, for example, in such an alternate configuration.

At step 1906, the substrate is moved in a second conveyance direction away from the transfer zone. The second conveyance direction can be different from the first conveyance direction. In the example first transfer zone 208 described above, the second conveyor 206 can move the substrate 230 away from the first transfer zone 208 in the second conveyance direction B. In the example shown, the first conveyance direction A and the second conveyance direction B are disposed perpendicular to one another. In other examples, the conveyance directions can be disposed at other relative orientations.

As explained above, the apparatuses and method of the present disclosure provide significant improvement over existing and/or conventional edge trimming processes and conveyance processes. The methods and apparatuses of the present disclosure allow substrates to efficiently and continuous moved through an edge trimming processes with cycle times not previously allowed using conventional methods.

The methods and processes described herein may be at least partially embodied in the form of computer-implemented processes and apparatus for practicing those processes. The disclosed methods may also be at least partially embodied in the form of tangible, non-transient machine readable storage media encoded with computer program code. The media may include, for example, RAMs, ROMs, CD-ROMs, DVD-ROMs, BD-ROMs, hard disk drives, flash memories, or any other non-transient machine-readable storage medium, or any combination of these mediums, wherein, when the computer program code is loaded into and executed by a computer, the computer becomes an apparatus for practicing the method. The methods may also be at least partially embodied in the form of a computer into which computer program code is loaded and/or executed, such that, the computer becomes an apparatus for practicing the methods. When implemented on a general-purpose processor, the computer program code segments configure the processor to create specific logic circuits. The methods may alternatively be at least partially embodied in a digital signal processor formed of application specific integrated circuits for performing the methods.

Although the subject matter has been described in terms of exemplary embodiments, it is not limited thereto. Rather, the appended claims should be construed broadly, to include other variants and embodiments, which may be made by those skilled in the art.

What is claimed is:

1. A method of separating an edge portion from a glass substrate comprising:
applying a scoring tool of a scoring apparatus to the glass substrate to cause the scoring tool to score the glass substrate along a score line as the glass substrate moves relative to the scoring apparatus; and
applying a breaker bar of a breaking apparatus to the glass substrate as the glass substrate moves relative to the breaker bar to separate the edge portion from the glass substrate along the score line.

2. The method of claim 1, further comprising contacting the glass substrate with the scoring tool after an edge sensor detects that a leading edge of the glass substrate has passed the scoring tool.

3. The method of claim 1, further comprising applying a score stabilization force to the glass substrate with a push roll unit.

4. The method of claim 1, further comprising moving the glass substrate relative to the scoring apparatus with a scoring conveyor.

5. The method of claim 1, wherein the step of applying the scoring tool to the glass substrate comprises applying a first scoring tool at a first edge portion of the glass substrate and applying a second scoring tool at a second edge portion of the glass substrate after an edge sensor detects that a leading edge of the glass substrate has passed the first scoring tool and the second scoring tool, the first edge portion disposed opposite to the second edge portion on the glass substrate.”

6. The method of claim 1, wherein the breaker bar comprises a plurality of breaker wheels that contacts the edge portion of the glass substrate.

7. The method of claim 1, further comprising applying a break stabilization force to the glass substrate with a plurality of holder wheels.

8. The method of claim 1, wherein the step of applying the breaker bar to the glass substrate comprises moving the breaker bar toward the edge portion of the glass substrate while the glass substrate moves relative to the breaker bar.

9. The method of claim 8, wherein the breaker bar moves in a breaking direction that is different from the movement of the glass substrate relative to the breaker bar.

10. The method of claim 1, further comprising moving the glass substrate relative to the breaker bar with a breaker conveyor.

11. The method of claim 10, wherein the breaker conveyor supports the glass substrate adjacent to the score line and is operable to adjust in a direction toward and away from the score line.

12. The method of claim 1, further comprising changing a conveyance direction of the glass substrate in a transfer zone from a first conveyance direction to a second conveyance direction, wherein:
the glass substrate is supported by a first conveyor when moving in the first conveyance direction and is supported by a second conveyor when moving in the second conveyance direction; and
the glass substrate is disposed at different vertical positions when supported by the first conveyor and the second conveyor in the transfer zone.

13. An edge separation apparatus comprising:
a scoring apparatus comprising a scoring tool configured to score a glass substrate along a score line;
a scoring conveyor configured to move the glass substrate relative to the scoring apparatus when the scoring tool scores the glass substrate;
a breaker apparatus comprising a breaker bar configured to separate an edge portion from the glass substrate along the score line; and
a breaker conveyor configured to move the glass substrate relative to the breaker apparatus when the breaker bar separates the edge portion from the glass substrate.

14. The edge separation apparatus of claim 13, wherein the scoring apparatus further comprises an edge sensor and a scoring actuator, the edge sensor configured to detect a leading edge of the glass substrate when the glass substrate moves toward the scoring apparatus, and the scoring actuator is connected to the scoring tool and is operable to move the scoring tool in contact with the glass substrate after the edge sensor detects that the leading edge of the glass substrate has moved past the scoring tool.

15. The edge separation apparatus of claim 13, wherein the scoring apparatus further comprises a push roll unit comprising a plurality of push rollers configured to apply a score stabilization force to the glass substrate.

16. The edge separation apparatus of claim 13, wherein the breaker bar comprises a plurality of breaker wheels configured to contact the edge portion of the glass substrate.

17. The edge separation apparatus of claim 13, wherein the breaker apparatus further comprises a holder unit comprising a plurality of holder wheels configured to apply a break stabilization force to the glass substrate.

18. The edge separation apparatus of claim 13, wherein the breaker apparatus further comprises a breaker actuator connected to the breaker bar, the breaker actuator configured to move the breaker bar in a breaking direction that is different from a conveyance direction of the breaker conveyor.

19. The edge separation apparatus of claim 13, further comprising a transfer conveyor positioned downstream of the breaker conveyor and overlapping a portion of the breaker conveyor in a transfer zone, wherein:
the transfer conveyor is configured to move the glass substrate in a second conveyance direction different from a first conveyance direction of the breaker conveyor; and
the transfer conveyor supports the glass substrate at a different vertical position than the breaker conveyor in the transfer zone.

20. A method of transferring a glass substrate from a first conveyance direction to a second conveyance direction comprising:
moving a glass substrate in the first conveyance direction into a transfer zone using a first conveyor;
transferring the glass substrate from a first transfer position on the first conveyor to a second transfer position on a second conveyor, wherein the first transfer position and the second transfer position are at different vertical heights; and
moving the glass substrate in the second conveyance direction away from the transfer zone, wherein the first conveyance direction and the second conveyance direction are different.

21. The method of claim 20, wherein the second transfer position is above the first transfer position.

22. The method of claim 20, wherein the step of transferring the glass substrate from the first transfer position to the second transfer position comprises lifting the glass substrate from the first conveyor to the second conveyor.

23. The method of claim 20 wherein the step of moving the glass substrate in the second conveyance direction comprises retaining the glass substrate on a bottom surface of the second conveyor.

24. The method of claim 20, wherein the glass substrate comprises a first surface and a second surface opposite the first surface, the first conveyor supporting the glass substrate on the first surface and the second conveyor supporting the glass substrate on the second surface.

25. The method of claim 20, further comprising moving a second glass substrate into the transfer zone while a first glass substrate is moved out of the transfer zone such that at least a portion of the first glass substrate vertically overlaps at least a portion of the second glass substrate.

26. A conveyance apparatus for transferring a glass substrate from a first conveyance direction to a second conveyance direction comprising:
a first conveyor configured to move the glass substrate in the first conveyance direction, the first conveyor comprising a first downstream end positioned in a transfer zone;
a second conveyor configured to move the glass substrate in the second conveyance direction, the second conveyor comprising a second upstream end positioned in the transfer zone that overlaps the first downstream end of the first conveyor; and
a lift unit positioned in the transfer zone comprising a lift actuator and a lifter, the lift actuator connected to the lifter to cause the lifter to contact the glass substrate and move the glass substrate from a first transfer position on the first downstream end of the first conveyor to a second transfer position on the second upstream end of the second conveyor.

27. The apparatus of claim 26, wherein the first conveyance direction is different from the second conveyance direction.

28. The apparatus of claim 26, wherein the second downstream end of the second conveyor is positioned above the first downstream end of the first conveyor.

29. The apparatus of claim 26, wherein the first conveyor comprises a belt to support a downward-facing surface of the glass substrate.

30. The apparatus of claim 26, wherein the second conveyor comprises a vacuum belt to support an upward-facing surface of the glass substrate.
